(19) United States
(12) Patent Application Publication
(10) Pub. No.: US 2012/0253828 A1
(43) Pub. Date: Oct. 4, 2012

(54) SYSTEM AND METHOD FOR SENSITIVITY OR NUTRITIONAL FACTOR EXPOSURE MONITORING

(76) Inventor: John A. Bellacicco, JR., Stamford, CT (US)

(21) Appl. No.: 13/078,081

(22) Filed: Apr. 1, 2011

(51) Int. Cl. G06Q 99/00

(52) U.S. Cl. 705/1.1

(57) ABSTRACT

A system for classifying and monitoring food and non-food products alike with respect to sensitivity or nutritional factor information comprising a database infrastructure storing product information for a plurality of products, a producer interface through which a product producer can input product information to be stored in the database infrastructure, and a consumer interface through which a consumer can define a profile containing sensitivities or nutritional factor parameter ranges requiring monitoring and which provides feedback to a consumer regarding products being consumed, applied or purchased and may be linked to their medical records. The product information for each product generally comprises one or more elements of sensitivity or nutritional factor metadata, and a consumer's profile defines one or more allergies, diseases or dietary conditions that identify associated sensitivities. Feedback provided comprises generating an alert when a consumer attempts to consume, apply or purchase a product that is either associated with sensitivities or outside nutritional factor parameter ranges defined in that consumer's profile. One such method using this system comprises monitoring a product selected for consumption, application or purchase by the consumer to identify if the product is associated with a defined sensitivity or is outside a defined nutritional parameter range and alerting the consumers when such products are selected to be consumed, applied or purchased.

### FIELD

The disclosure herein relates generally to diet planning, but more specifically to leveraging sensitivity or nutritional factor metadata to enable safe and healthy living.

### BACKGROUND

Many people are affected by medical conditions that require strict elimination of food, medicinal and personal care product classes, e.g., severe food allergies, allergies to medications, celiac disease, eosinophilic esophagitis (EE), or other autoimmune conditions. If a person has one of these conditions, lack of adherence to a strict diet can be extremely hazardous. Life threatening reactions can be triggered by even the smallest amount of contact with or ingestion of proteins from the food(s), medicinal and or personal care products at the heart of a condition. Other conditions like diabetes, obesity, or heart disease—although less immediate in their harmful effects—also require a strict dietary adherence can benefit from this system as described.

For people with these conditions, shopping for both raw and prepared foods becomes an extreme burden. Hours are spent combing through grocery stores, reading food labels and calling manufacturers in order to find and verify products that are safe for the consumer. The same issue exists for food service establishments that wish to cater to such individuals. Verification of the product's ingredients and processing methods is critical for the consumer's safety and often times extremely laborious. In many cases the consumer has to contact the product's manufacturer via phone or email and understand the product's processing method, ingredient and ingredient sources. Many times factors vary from production plant to production plant. Additionally, representatives of these manufacturers are usually only available on weekdays during their normal business hours. This results in very limited availability of critical information necessary to keep the consumer safe.

Food products are not the only area of concern for people affected by these conditions. Non-food products that may be ingested or contacted by a person, e.g., cosmetics (lip sticks), soaps, pharmaceuticals or tobacco products can also contain triggering ingredients. In the case of allergies to medications, without inclusion in a patients medical records and a way to track and monitor adherence to this condition, life threatening event avoidance is left to multiple hand written charts and the care givers/patients diligence in reviewing the restrictions.

### SUMMARY

The present disclosure provides a system and method for classifying food and non-food products alike with respect to sensitivity or nutritional factor information. Specifically, the system comprises a database infrastructure storing product information for a plurality of products, a producer interface through which a product producer can input product information to be stored in the database infrastructure, and a consumer interface through which a consumer can define a profile containing sensitivities or nutritional factor parameter ranges requiring monitoring and which provides feedback to a consumer regarding products being consumed, applied or purchased. A consumer's profile can also define one or more allergies, diseases or dietary conditions that identify associated sensitivities, as well as alert levels defined in a consumer's profile for each sensitivity or nutritional factor parameter range. Further, the product information for each product generally comprises one or more elements of sensitivity or nutritional factor metadata, such as allergen metadata, certifications or classifications.

The feedback provided comprises generating an alert when a consumer attempts to consume, apply or purchase a product that is either associated with sensitivities or outside nutritional factor parameter ranges defined in that consumer's profile. The alert is generally one of an e-mail, text audible, or visual message.

The database infrastructure generally comprises a plurality of databases, one each for product metadata, use metadata, system rules, and profiles. For instance, the database infrastructure can include a product metadata database including entries for elemental products and compound products, the compound products comprising one or more elemental products and one or more compound products, or a use metadata database including entries for menus, recipes or shopping lists, each menu, recipe or shopping list comprising one or more defined elemental or compound products.

The system can also include a rules engine facilitating the monitoring of sensitivities or nutritional factor parameter ranges defined in a consumer's profile by comparing those sensitivities or nutritional factor parameter ranges to the one or more elements of sensitivity or nutritional factor metadata associated with products selected by the consumer for consumption, application or purchase. A search engine may also be included permitting consumers to search products stored in the database infrastructure by identifying one or more elements of sensitivity or nutritional factor metadata. The search engine permits a consumer to search for elemental products and compound products defined in the product metadata database by comparison to the sensitivities or nutritional factor parameter ranges defined in that consumer's profile.

The consumer interface further permits a consumer to define new menus, recipes and shopping lists by excluding products associated with allergen, disease or nutritional factor parameter ranges defined in that consumer's profile.

An interface to an electronic shopping cart or a barcode scanner can also be included permitting the rules engine to determine if products added to the electronic shopping cart or scanned by the barcode scanner are either associated with sensitivities or outside nutritional factor parameter ranges defined in a consumer's profile.

One such method using this system comprises monitoring a product selected for consumption, application or purchase by the consumer to identify if the product is associated with a defined sensitivity or is outside a defined nutritional parameter range and alerting the consumers when such products are selected to be consumed, applied or purchased.

Further areas of applicability of the present disclosure will become apparent from the detailed description provided hereinafter. It should be understood that the detailed description, including disclosed embodiments and drawings, are merely exemplary in nature, intended for purposes of illustration only, and are not intended to limit the scope of the invention, its application, or use.

### BRIEF DESCRIPTION OF THE DRAWINGS

FIG. 1 illustrates an exemplary diet planning and monitoring system.

FIG. 2 illustrates an example schema for product metadata.

FIG. 3 illustrates an example schema for recipes, shopping lists and menus.

FIG. 4 illustrates an example schema for system rules.

FIG. 5 illustrates an example schema for profiles.

FIG. 6 illustrates an example embodiment of the FIG. 1 system in use at a retailer, e-tailer or product source.

FIG. 7 is a flow chart illustrating producer profile creation of EPs, CPs, recipes and menus.

FIG. 8 is a flow chart illustrating creation of consumer profile data.

FIG. 9 is a flow chart illustrating consumer profile searching for products and recipe, menu, or shopping list creation.

FIG. 10 is a flow chart illustrating alert handling.

FIG. 11 illustrates a network diagram of the FIG. 1 system.

### DETAILED DESCRIPTION

Current best practices for finding products that match sensitivity and nutritional, cosmetic and drug safety requirements are limited to a few alternatives. One way to do so is by finding specific manufacturers that provide a specific and limited set of safety or nutritional requirements. Another is use of e-commerce websites (e.g., amazon.com) that provide keyword search capability for a certification such as “gluten free”. Finally there are a variety of websites that provide guidance through crowd-sourced information, such as those that allow searching in local living areas for restaurants that users of the site rate according to their perceived ability to manage food allergies.

All of these methods are helpful to an individual searching for a product or service that can meet their needs. However, these methods are limited. The information they provide is opinion at best and not reliable. Even in the best case, the ability to keyword search in current systems for “gluten free,” cannot provide the consumer with any traceability for the product ingredients or in some cases no definition of the certification behind the claim, e.g. “gluten free.” Keyword searching alone can be especially unreliable. For example, a search for “peanut free” products on a popular e-commerce website yields not only supposedly peanut-free human-edible consumables, but sugar free products containing peanuts (sugar free peanut butter) and peanut-free dog food as well. Such limited methods of searching and verification are not satisfactory for consumers whose life may depend on the accuracy and correctness of the information.

The present disclosure provides a system and method for classifying products with respect to sensitivity or nutritional factor information that consists of a metadata database where producers (e.g., processed food manufacturers, raw food grower/suppliers and non-food product manufacturers, pharmaceutical manufacturers, food service establishments) can aggregate information about their products. This aggregation in turn provides the consumer with a total supply/value chain view of such products. Subsequently, consumers (e.g., individuals, retailers, e-tailers, food service establishments, or any organization or entity required to monitor product content) can leverage this metadata to identify products or ingredients with desired sensitivity or nutritional factor attributes. Provider metadata entry and consumer data retrieval are accomplished through Internet-accessible portals (or intranet portals in the case of private implementations of the system). Compared to the prior art, the disclosed system and method provides users with allergies or dietary conditions with a true authoritative source, using detailed metadata content and traceability along with accurate search results.

The system and method optionally includes a variety of additional components including a recipe database, a recipe building tool, restaurant menu building tool, and a shopping list tool, all to aid in the identification and acquisition of acceptable food or non-food products. Both product information and recipes can be stored in a single database or a federation of multiple databases, each of which can have a different owner. For instance, each producer may have a database for its own products.

Using the described system or methods, a provider can create metadata describing attributes of food stock and other products including allergen information, calorie count, cholesterol—categories for any and all restrictive attributes can be properly described. Types of data that can be entered include, but not are limited to: allergen data, processing data (e.g., line cleaning method), nutritional data, availability data, and pricing. In general, products are organized in to two categories: “elemental products” (EPs) and “compound products” (CPs), both of which can be ingredients in other compound products, or combined to create recipes or menus.

An EP contains a single ingredient that is made, grown or manufactured by a producer. Typically, the producer of an EP manages the whole supply chain for its production. Examples include celery, cocoa, coffee, sugar, and the like. The producer is the authoritative source for information about the EP and also classifies/certifies the process for making it into a viable product. The producer can also immediately associate the EP with known allergens. EPs can be structured to permit them to be used as common ingredients. That is, both a common name (i.e., scientific name) and a product name (i.e., a brand name) can be stored.

A CP contains multiple EPs sourced from the same or different manufacturers/processors stored as an “Ingredient List” with an associated process that describes how those ingredients are aggregated into a final product. The producer of the CP is responsible for classifying/certifying EPs it is the source for, its process for combining EPs and CPs and the new CP as a whole. Examples include a menu item at a restaurant (chicken tenders), a consumer product (lipstick, cosmetics), a processed food product (Rice Krispies®) or a pharmaceutical. A CP is recursive; in other words, CPs can be made by combining other CPs in a defined process. Like with EPs, CPs can also be structured to permit them to be used as common ingredients—an illustrative example is that there are many different brands of vanilla ice cream. EPs and CPs can also be organized in class types and subtypes and all data structures discussed herein can be treated as objects in order to better facilitate the aggregation of metadata.

CP metadata typically includes manufacturing, classification and certification data for the whole supply chain, including any direct associations with allergens. The underlying certifications and classifications for the ingredients of a CP thus need not necessarily be searchable. This is important where ingredients in a CP or recipe need to be kept secret (such as in the case of a trade secret formula). If a CP is to be certified, a CP producer must certify the whole supply chain for the CP ingredients—a portion of the underlying metadata for the CP's ingredients can than be hidden or not searchable in order to protect the formulary of the CP. For instance, exact measures and process steps can be hidden.

A “recipe” is a collection of EPs and CPs along with reference to information defining a “process” for combining them into a product. EPs and CPs may be sourced from different providers. The difference between a CP and a recipe is that a CPs production process can be proprietary and not revealed, but the process certified for compliance. Recipe processes are described as part of the recipe; generally, the recipe itself has no certification but may have a classification data entry which provides guidance in how to meet one (such as, how to make a cake gluten-free). The recipe can additionally refer to EPs or CPs by common name. As an example the recipe may call for flour, without specifying a particular producer.

A “menu” is a listing of one or more separately describable and orderable EPs, CPs and recipes. The elements of the list are not combined by a process, but may merely describe the products offered by a single provider, i.e., a fast food restaurant.

“Shopping lists” are listings of one or more separately describable and orderable EPs, CPs and recipes. The elements of the list are not combined by a process, but may simply describe the products intended to be purchased by a consumer. A shopping list differs from a menu in that a shopping list is created with the intent to order the product and may include an assortment of products that are foods and non-foods. An example would be a list containing lipstick and celery. Shopping lists are generally associated with a consumer e-commerce or retail/wholesale transactions.

As noted above, metadata that is collected for CPs generally includes at least two types of information: “certification”, i.e., verifiable data which notes compliance with a governmental, industry or other standard, generally monitored by a governing body, and “classification,” i.e., a categorization and sorting of products based on processes meeting the (certification) standard. Certifications exist for well known dietary restrictions and/or classifications such as “gluten-free” or “nut-free”. The definitions of the certifications used may come directly from the governmental or industry body. The system may also be the governing body and use its own certification/classification scheme with its own definitions. This “private” standard may or may not be related to the governmental or industry standards.

As an example, certifications could be private to the system described herein and implemented so that the certification definitions were at least as stringent as the most stringent governmental or industry definition. This would facilitate a more globally acceptable (yet still stringent) standard. Another example would be that different countries have slightly varying definitions of gluten free. If the system has its own certification standard, the standard might contain a definition of gluten free that was at least as stringent as the most stringent public definition. Because of this, consumers would then have more confidence in the certification. In addition to being the categories for classified products, classifications identify product exposure to potential adverse ingredients, i.e., dairy, nuts, or the like. This data, which is generally stored along with system rules for diseases or dietary conditions, forms a rule set by which the system can operate. Producers can be designated as “authoritative sources” for EPs and CPs that they produce—allowing them to be responsible for managing and, maintaining the certification and classification metadata for their products.

Of course, EP and other CPs that are the ingredients of a CP in question may have the same or different authoritative sources. Authoritative source identification is carried through in the metadata. In one implementation, only an established authoritative source can create CPs. A CP cannot be entered into the system unless 1) all of the ingredients for the CP are already in the system; and 2) the authoritative source of the CP to be created is also the authoritative source for all of the other ingredients (EPs and CPs); or 3) the producer of the new CP has the authoritative source (producer) of any missing ingredients first enter their EP's or CPs into the system. It should further be noted that when creating CPs, the system is capable of reviewing all the certifications or classifications associated with constituent EPs and CPs and prevent that new CP from having a certification or classification that is stricter. For example if a CP “A” is classified as “made in a facility that contains peanuts” a CP “B” that contains that CP “A” cannot be classified as peanut free.

The system is designed to be accessed through the Internet in the home or place of business using a personal computer, or elsewhere using a hand held or other pervasive computing device like a smartphone or tablet computer. Alternatively, the system can be accessed directly at a point of sale, such as a supermarket, either via a store kiosk or through a checkout or store loyalty system. For instance, a user can register directly or port their dietary preferences or restrictions into a store or restaurant loyalty system or other personal ID (e.g., college ID, work ID), and the checkout system can be adapted to review and optionally warn the user of prohibited products being purchased—accidentally or otherwise. It should be noted that a local copy of the portal application as well as the databases can be cached to aid access when Internet connectivity is not available.

Through a consumer portal, for instance, a consumer can create a personal profile. This profile could be stored as part of a database associated exclusively with the consumer portal or in a common database with all the necessary privacy precautions in place. In addition to information generally required for e-commerce applications (name, contact information, etc.) the consumer profile could include fields to capture allergens, ingredients, EPs (these are just some examples of “sensitivities,” as used herein) or health-related nutritional factor parameter ranges (Le. no foods with sodium over 100 mg/serving) that are important to the consumer's dietary or personal needs. The consumer would also be able to enter any medical condition (i.e., celiac's disease) and the system would be able to translate that affliction to a known set of sensitivities and thus a set of EPs or CPs to exclude. That is, the allergens, diseases or dietary conditions define a set of sensitivities associated with the consumer, allowing the consumer to identify food or non-food products he or she should not consume. From the defined allergens, diseases or dietary conditions information alert levels can be inferred, set and be propagated to store or restaurant loyalty systems, personal IDs, medical records or health insurance records. Conversely, at the time of profile creation, known medical conditions can be pulled into the profile from consumer medical and insurance records if so indicated. Medical conditions can also be used to generate inclusive sets of sensitivities and nutritional parameter limits used to select and categorize acceptable EPs or CPs. A list of known medical afflictions along with their set of inclusions/exclusions are stored as part of the rules database and maintained by an authority on the subject per known standards of health (such as guidelines from the AMA, FDA, CDC, or other trusted source). It should be noted that the system should be truly ‘multi-tenant,’ meaning that the system is implemented in such a way that proper security application and data management structures are in place to ensure adequate privacy and compliance with governmental regulations (i.e. HIPPA).

Once a consumer profile is created it could be linked to, as noted above, a store or restaurant loyalty system or retailer/wholesaler specific shopper profiles (i.e. an amazon.com profile) or a food service establishment ID (e.g., college ID) and used to alert a consumer prior to checkout that they are about to purchase a product that is either dangerous or at a minimum, contrary to their expressed profile needs. The alert component of the system and profile can also be extended to interact with a consumer's medical records, and import data from or export data to those records. By doing so, the link to the profile data can be used to ensure medications being given to the consumer do not contain known allergens or restrictions the consumer is under (i.e. vaccines containing eggs or mercury). This could be especially important and potentially lifesaving in clinic situations where only specific medications are being dispensed outside of the normal doctor's office or hospital (e.g., flu shots given out at the local pharmacy) and the consumer (patient) is not aware of the ingredients. Consumers can also, when setting up their profiles, select afflictions/allergens/nutritional guidelines and a rank to associate with each, e.g., a simple value out of 10 which identifies the nature of the association. For instance, allergens which cause anaphylaxis (are “deadly”) for the consumer can be ranked “1” as most important.

By tracking what a consumer buys via orders placed, loyalty card data, and the like, the consumer can also be sent a targeted alert if it is later determined a product purchased was cross contaminated with an allergen during processing, or if a product has been recalled. A decision for when an alert is sent can be based on the afflictions/allergens/nutritional ranking. The consumer can also choose individually on what metadata an alert should be sent for, e.g., when a product is put into a shopping list, at order or checkout time. Also, an after that fact alert (if it was later discovered that manufacturing processes failed and contamination happened) could be sent to all consumers who purchased the product.

The consumer profile can be optionally downloaded and saved on grocer rewards cards, credit cards or even on a dedicated personal smart card that can be used in the case of purchases made at a grocer, food service establishment or other retailer (brick and mortar or otherwise) that may have a private system not connected publicly but available for use by their customers. Similarly, the profile could be downloaded to a smartphone or other mobile device and interfaced via near field communication (NFC) or similar technology.

Accurate and swift determination of the ingredients of a food, qualitative factors describing the food (calorie count, cholesterol and the like) as well as the possible cross contamination of that product with others in the manufacturing and packaging processes is vital. Thus, the system can support multiple methods of quantifying product metadata when searching. For instance, a user can set multiple flags to restrict the results and support relative indicators. For allergens, the user can be provided with choices to search for products a) free of that allergen, b) containing the allergen; c) free of the allergen but is processed on a line that is cleaned but also processes the allergen, or d) is processed in a facility that contains the allergen. For nutritional attributes, i.e., “Low” cholesterol product or another attribute with similar characteristics, a search can provide a ranking of a certain type of product by different suppliers and by the amount of cholesterol contained by serving or other measurement. Where multiple food allergies or other food attribute conditions are involved, the system supports restricting the search by multiple allergens as well as nutritional data.

A system such as this not only improves the safety of the consumer for products they are choosing but it also would help improve the overall quality of consumable consumer products. It accomplishes this by putting small producers who concentrate on higher quality products (organic, allergen free, etc.) on par with large producers by exposing consumers to the benefits of the small producer's products.

An important aspect of the system is that it is not limited to simply searching for allergen or nutritional attributes but is able to aggregate products into recipes and menus that are either developed to have particular nutritional attributes or that are free of specified allergens, and is also able to create a shopping list and provide the ability to order the chosen items through one or more sources based on the described recipes and menus.

As noted above, the system can federate data from multiple copies of similar systems run by multiple organizations. The data can be partitioned into public or private views through separate database instances or by setting flags in the metadata or by any other practical means. For example, producers can have a private version of the system that they manage and the data for that system may then be federated with a system from one or more of their distributors. Data can be kept in a common format by every organization or templates can be developed to map an organization's current data to common (e.g. format for the version of the system being operated (e,g., different systems for producers, distributors, consumers, etc.). Within this federation, a master database can verifiably identify each organization as “authoritative” of certain products, so that the data kept by that organization is properly aggregated to systems accessed by consumers and meets industry accepted certification and classification criteria. Thus, users of the system can have their own local implementation, as can large scale producers. Further, a master authoritative source could be established (e.g., a government entity).

The system thus allows a total supply chain view of products and corresponding metadata that would end up in a menu or shopping list and allows a consumer to search or shop by exception. Both the consumer and producer portals can have a reporting tool linked to them. For producers, reports can be generated to show the aggregate healthiness of the products they produce as well as if there has been any excursions (alerts) because of processing errors that have put unreported allergens into products. For consumers the reports could show overall healthiness of the products they are ordering (i.e. diet) as well a listing of alerts. The consumer report can also choose to have the reports linked to their electronic health records so that their doctor, nutritionist or other health services provider could review the records.

### DETAILED DESCRIPTION OF THE FIGURES

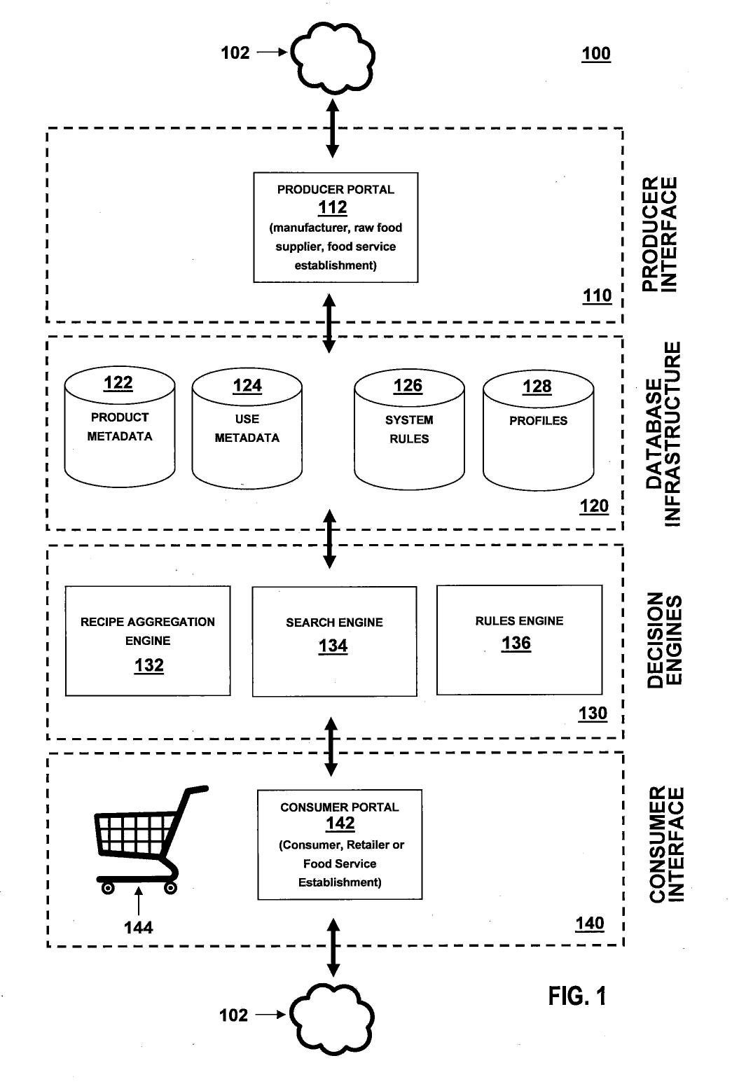

FIG. 1 illustrates an exemplary diet planning and monitoring system 100 organized with four primary structures: a producer interface 110, a database infrastructure 120, decision engines 130 and a consumer interface 140. The producer interface 110, which is connected to a network 102 such as the Internet for producer access, comprises an accessible portal 112 where a manufacturer, raw food supplier, or food service establishment can enter or provide product metadata for use in the system 100, via the database infrastructure 120. Of course, the manner in which such information is collected and received varies, but can include Internet web bots, data streams, electronic ticker feeds, RSS feeds, e-mail, fax, disks, or any other known or conventional means of information delivery. All such examples are within the purview of the producer interface 110.

The database infrastructure 120 consists of one or more databases. As shown in FIG. 1, one example of infrastructure 120 comprises four databases: one for product metadata 122, one for use metadata 124 including recipes, shopping lists, and menus, one for system rules 126, and one for profiles 128. These database(s), which could be Microsoft SQL or MySQL, IBM DB2, Informix, Oracle or any other object oriented or relational database management system running on a UNIX, Linux, Windows, Apple OS, Android or any other appropriate platform, store all the information necessary for system 100 to properly implement planning and monitoring tasks, which are accomplished through decision engines 130. It should be understood that the database infrastructure 120 could be federated multi-tennant, meaning that providers or consumers may each have separate databases which are aggregated by the system 100 into a single access point and that the system design is such that the proper security application and data management structures are in place to ensure adequate privacy and compliance with governmental regulations (e.g., HIPPA) and as dictated by the business relationship between the owning entities .

Decision engines 130 provide functionality for consumer interaction with consumer interface 140. In FIG. 1, three such engines 132, 134 and 136 are shown. Recipe aggregation engine 132 allows consumers to construct recipes for storage in recipes, shopping lists, and menu database 124 by selection of products from product metadata database 122. Search engine 134 provides consumer search capabilities for product metadata database 122, such as searching by allergen-free, condition acceptable, etc. Rules engine 136 provide comparison services to the consumer, i.e., the ability to check a given product or recipe for compatibility with that user's profile, as stored in profile database 128. It should be understood that the various decision engines 130 can be software application programs running on individual, shared, or even virtual processors.

Consumer interface 140 can comprise a consumer portal 142, for consumers, retailers, food service establishments, or the like, and also a shopping cart interface 144, for consumer interaction through procurement sources, whether physical (e.g., the local supermarket) or electronic (e.g., amazon.com). Like the producer interface 110, consumer interface 140 is accessible via a network 102 such as the Internet. These interfaces 110, 140 can be implemented in any number of known formats (e.g., terminal input, Windows program, HTTP based web form, communications link(s), etc . . . ).

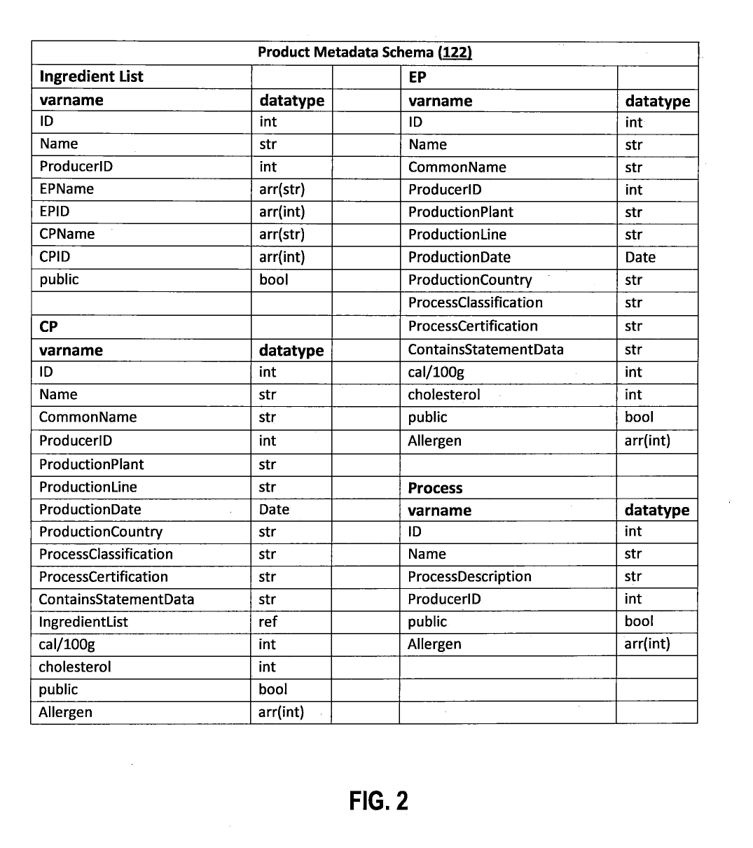

FIGS. 2-5 illustrate exemplary schema for product metadata, recipes, shopping lists and menus, system rules, and profiles. As can be observed in FIG. 2, the product metadata database 122 contains four primary data structures, elemental products (EPs), compound products (CPs), Ingredient Lists and Processes. Each structure defines a plurality of exemplary metadata entries which make a whole record.

For each EP, the exemplary schema provides: an identification number; a name; information identifying how the EP is produced, including a producer contact (which can be a reference to a consumer profile), plant or line ID, date range, or country; identification whether the EP meets any classifications or certifications; identification of any packaging statement data; and nutritional data such as calories per 100 grams or cholesterol per serving. Of course it should be understood that the nutritional data can be collected in any form consistent with intended goals of the system as it is implemented. For each CP, stored data is collected similarly to that for EPs, except for an additional reference to an Ingredient List, a referential structure which contains one or more EPs and one or more CPs. Process data, including process descriptions, are also stored.

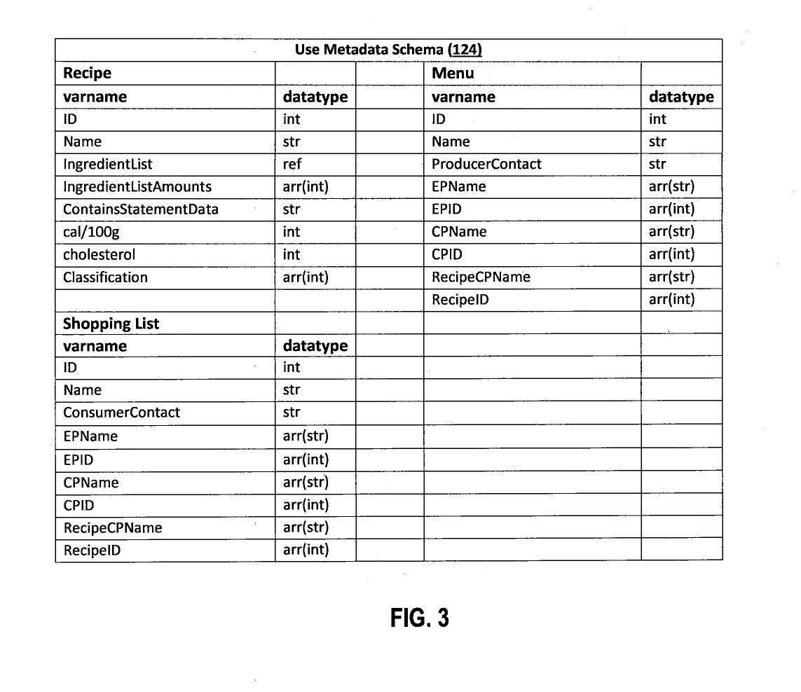

FIG. 3 shows the use metadata database 124 which contains data structures for menus, shopping lists, and recipes. Recipes, which are similar to CPs in structure, include ID data, name data, and nutrition data as well as an Ingredient List structure. Menus and shopping lists are similar constructs, each containing one or more EPs, CPs and Recipes. Since menus can be associated with producers, producer contact info is included. Likewise, for shopping lists, consumer contact info can be included.

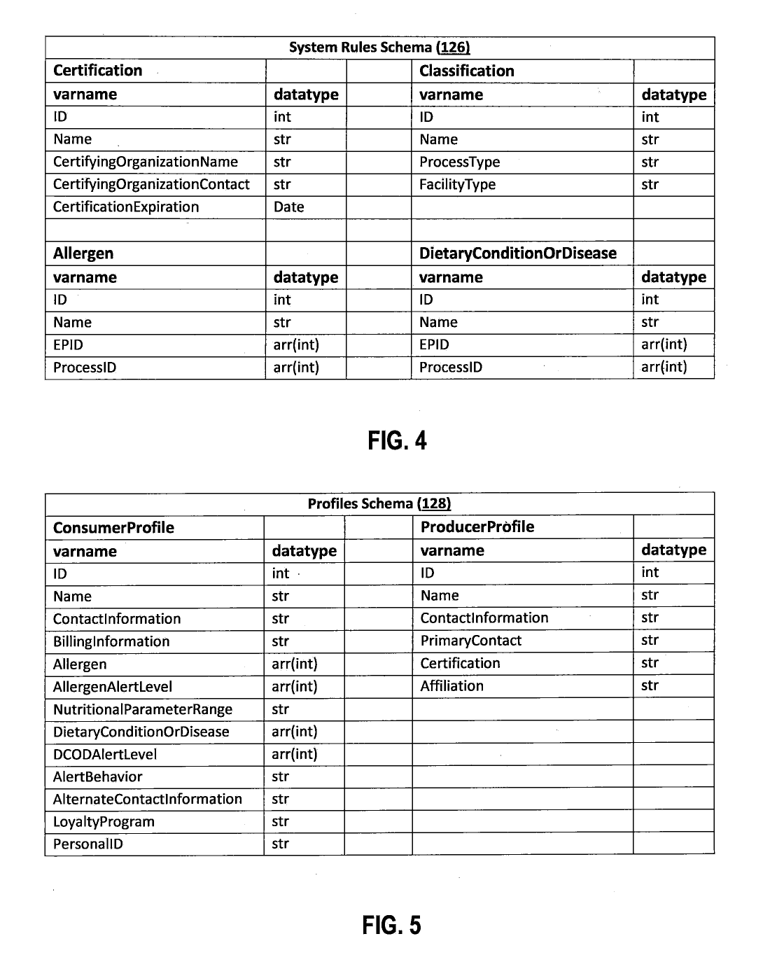

FIG. 4 illustrates rules schema structures, which include certifications, classifications, allergens, dietary conditions and diseases. The data in this schema allows the system to make determinations about whether a consumer is permitted to buy or consume EPs and CPs. Certifications, which as noted above relate to compliance, contain both ID and name data as well as certifying organization name and contact information, and certification expiration data. Classifications, which as noted above relate to process intermixing, contain ID and name data and process and facility type data, as well as producer contact information. Allergen or Dietary Condition data is also stored in this construct, which identify specific core EPs or processes associated with both allergens (i.e., single food allergies) or dietary conditions (i.e., celiac). Data can be stored redundantly within these constructs, such that EP allergen or condition data can also be stored within the EPs themselves.

Lastly, FIG. 5 shows profile data structures for consumers and producers, both including ID, name and contact information. Consumer's profiles can further include billing information, allergen or dietary condition data, as well as nutritional parameter range data, which relates to nutritional data stored with EPs and CPs. For instance, a consumer can state that no EP consumed has cholesterol in excess of 70 mg/3 oz (typical for high-fat beef products). In each consumer profile, alert levels and behavior can be set to allow customized notifications at varying levels of intensity. For instance, a maximum alert level could be set for an allergen that a consumer is highly allergic to, i.e., a peanut allergy which causes severe anaphylactic shock. In the case of a maximum alert level, the alert behavior could involve multiple high priority e-mails or text messages, automated phone messages or a message sent to an interacting system to immediately inform the consumer and if indicated an alternate representative of the consumer of the presence of the allergen. Such data can be optionally included in a field in the consumer profile in the event the consumer requests such notification. By contrast, a minimally severe alert level could be assigned to an allergen that a consumer wants to avoid but is not strictly allergic to, which could result in a simple informative message being displayed or an e-mail to be sent by the system. Producer profiles can, in addition to contact information, store certification information which applies to all products authoritatively identified with that producer (e.g., for all-vegan producers).

Although a traditional consumer/producer relationship is herein described, an entity can have both a producer and consumer profile and depending on which side of the produce/consume (buy/sell, offer/use, etc . . . ) transaction they are they will fulfill the role of producer or consumer. For instance, a consumer can also be a user of the product in a company, or, for an internal use only version of the product a consumer could be the “product developer” using this application to do a restricted internal company database search to find ingredients for the product being developed. A consumer could also be a retailer shopping through a wholesaler. Conversely a producer could be a restaurant owner providing the menu items for retail.

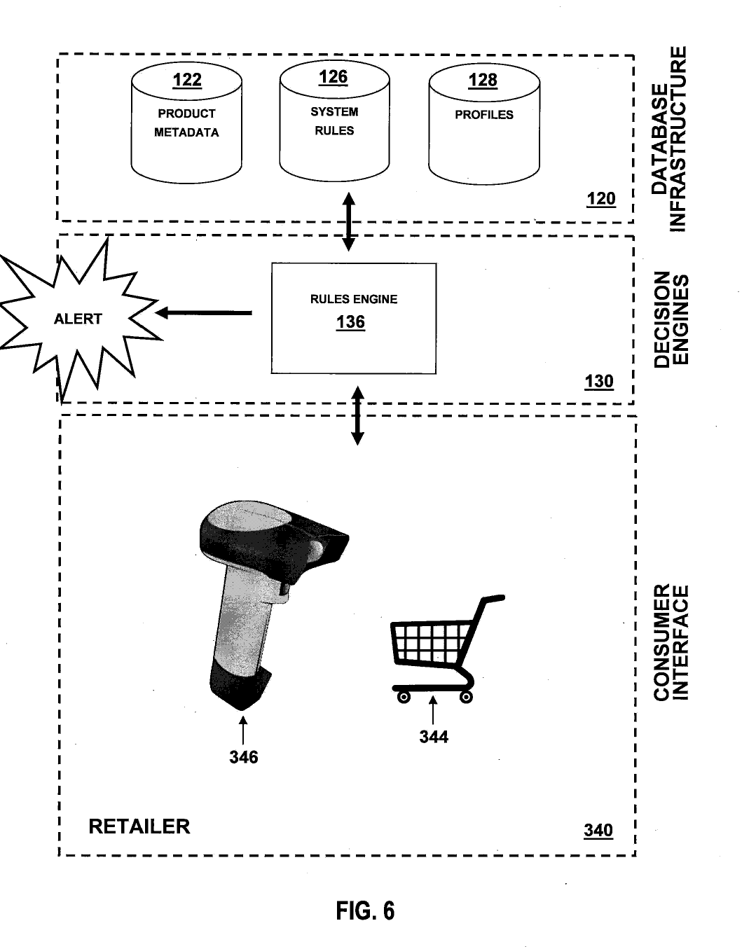

FIG. 6 illustrates an example of a system 100 as implemented in a retailer such as a supermarket. As shown therein, a consumer interface 340 specially adapted to the retailer contains a shopping cart 344 and electronic checkout system 346. It should be understood that the electronic checkout system 346 could be one of a traditional point of sale system or a “self-checkout” portable scanner system. As items are selected by the consumer and scanned (into shopping cart 344), rules engine 136 is programmed to monitor (using rules stored in 126) EP and CPs for the presence of sensitivity or nutritional factors (stored in 122) defined in a consumer's profile (stored in 128). In the event a detection is made, rules engine 136 is programmed to alert consumer. This alert can be accomplished by any known means, including directly through electronic checkout system 346 (audible or visual warning) or via e-mail, SMS, automated phone message or other contact means recorded in the contact information of the consumer stored within the profile database 128.

It should be noted that although only the primarily active elements of system 100 are shown; it should be understood that all FIG. 1 components could be included in the FIG. 6 system.

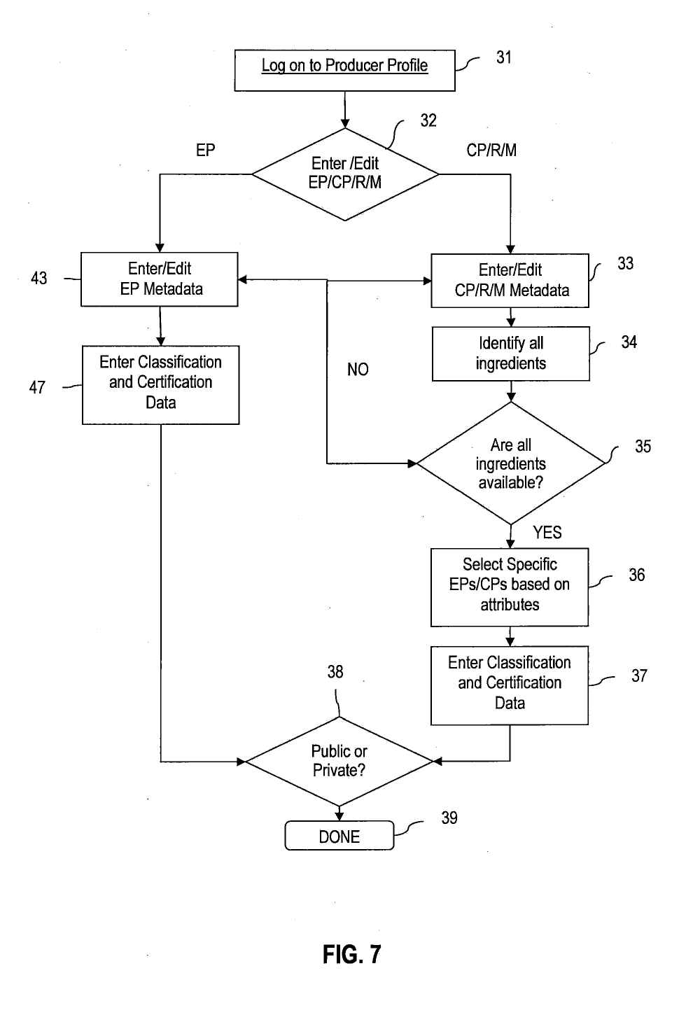

FIG. 7 shows a flow chart illustrating a producer interaction within the FIG. 1 system. It should be understood, as an example, that any flow chart steps described below could be carried out via a series of web-based forms. Beginning at step 31, a producer will log on to their profile, and proceed to enter or edit associated EPs, CPs, recipes or menus at step 32. If an EP is to be entered or edited, metadata associated with the EP can be edited at step 43. Next, classification and certification data is edited at step 47. If a CP, recipe or menu is to be entered or edited, metadata is entered at step 33. Next, at step 34, a list of ingredients are identified. If the producer represents all the ingredients are available in the system, specific EPs or CPs corresponding to those ingredients can be selected in step 36. For instance, a certain type of common product can be selected. If not, the producer can be directed to enter those ingredients, as EPs or CPs if needed. As with EPs, classification and certification data is entered/edited at step 47. At step 38, once classification and certification data is entered/edited, the producer can set the visibility of the product (public or private).

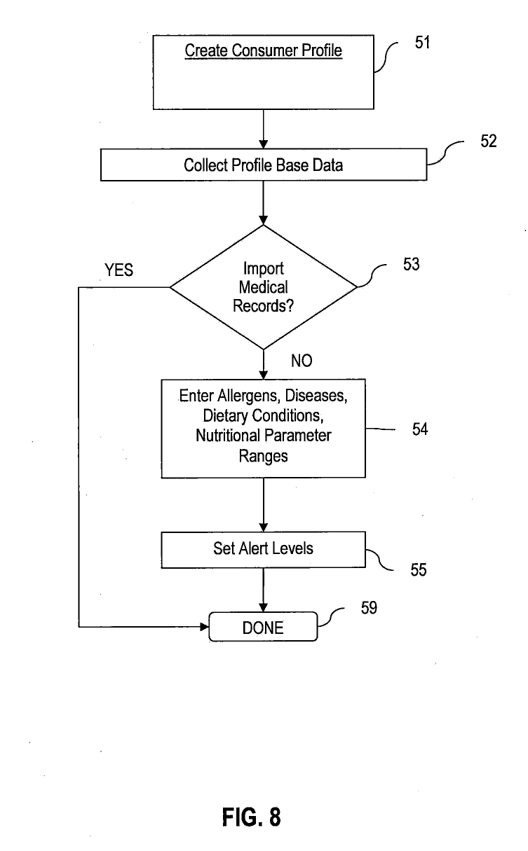

FIG. 8 shows a flow chart illustrating creation of a consumer profile. At step 51, the data structures for the consumer profile are initiated. Next, at step 52, profile base data such as contact information is collected. At step 53, medical records of the consumer can be imported to automatically populate allergens or dietary condition data, along with nutritional parameter range data (i.e. doctor's recommendations), along with alert levels. Otherwise, steps 54 and 55 allow this data to be inputted manually.

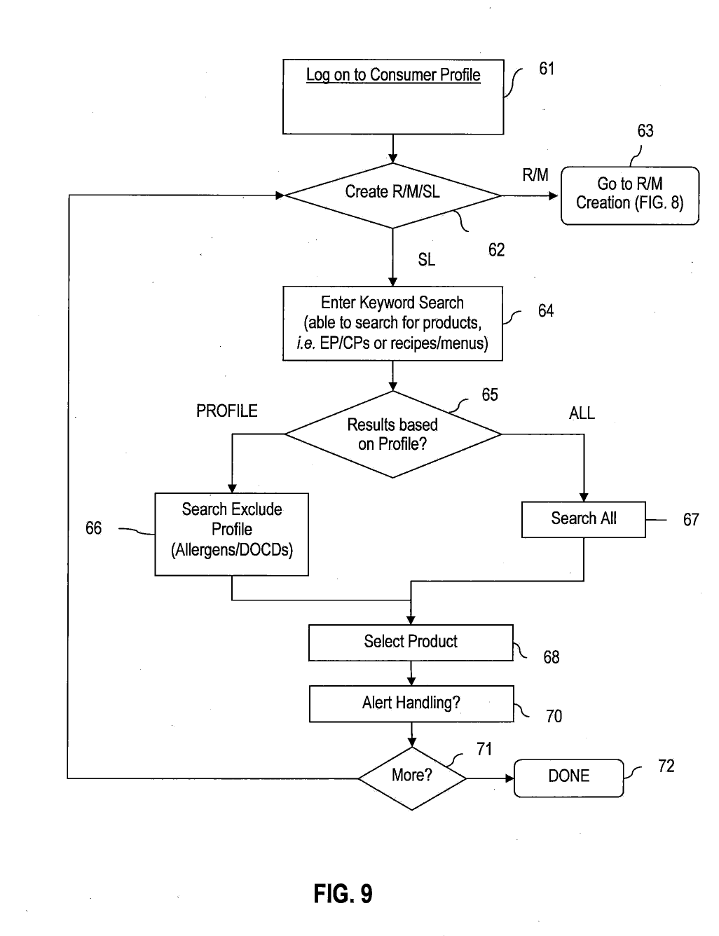

FIG. 9 shows a flow chart illustrating consumer interaction and construction of recipes, menus, or shopping lists. At step 61, the consumer logs in and profile information is loaded from the profile database 128. Next, at step 62, the user is prompted to identify the type of structure they wish to create. If the structure is a recipe or menu, the consumer is directed to a FIG. 7 process for selecting/creating ingredients. If the structure is a shopping list, the consumer is directed to search engine 134 at step 64, where keyword search for products (i.e., EPs, CPs, or recipes/menus) is permitted. The consumer is prompted whether they wish to restrict results based on their profile (step 65). If so, results are presented which exclude allergens or dietary conditions defined in the consumer profile (step 66). Otherwise, all results are displayed at step 67. The consumer is next prompted at step 68 to select a product. Alert handling is processed at this stage (step 70), if the consumer has selected a product for which an allergen (whether directly or indirectly via a dietary condition) is defined, or which is outside a defined nutritional parameter range. The process can be repeated for multiple products (step 71) or completed (step 72). It can be appreciated that the same flow of product by product checking against the consumer profile can be applied in a loyalty system environment, e.g., the system shown in FIG. 6, wherein each item scanned by scanner 346 is so checked.

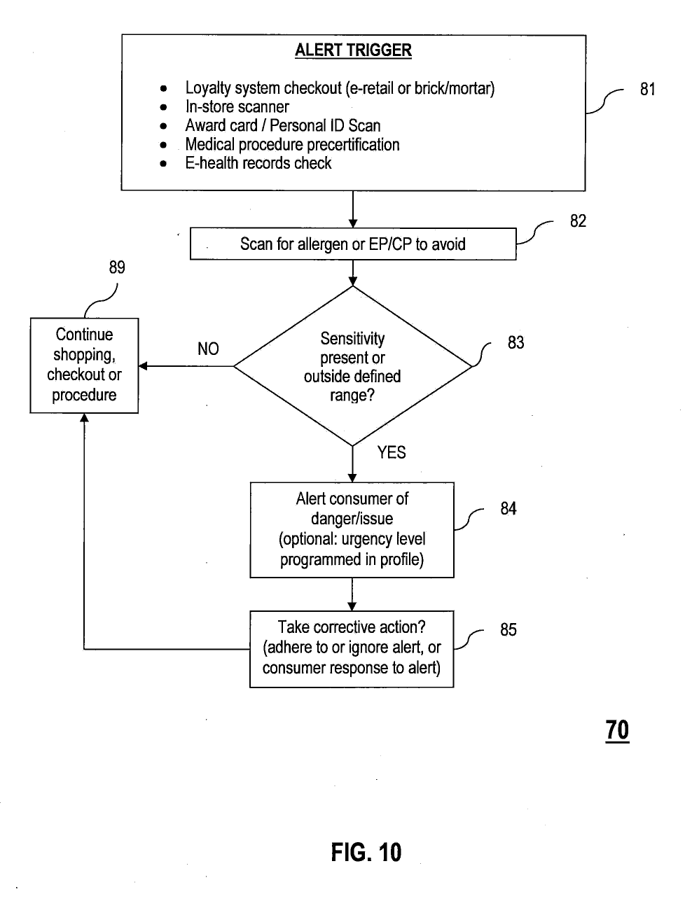

FIG. 10 shows alert handling step 70 from FIG. 9 in greater detail. At step 81, a number of conditions are checked to trigger an alert. For instance, as noted above, the product may be scanned by a scanner 346 or placed in an electronic shopping cart 344, that is, software which allows online shopping customers to accumulate a list of items for purchase, described metaphorically as “placing items in the shopping cart”. Upon checkout, the electronic shopping cart 344 facilitates calculating a total for the order, including shipping and handling (i.e. postage and packing) charges and the associated taxes, as applicable, and interfacing with an order processing system.

At step 82, EP/CPs are scanned for allergens or nutritional parameter ranges. Those which are detected as present (step 83) produce alerts (step 84) according to the consumer profile. Optionally, the alert level defines the response that the system takes, as noted above. The alert level may require a corrective action (step 85) to be taken, e.g., the product's removal from the consumer's electronic shopping cart, or require an affirmative response from the consumer that they understand they are sourcing a product which conflicts with their profile. The shopping, checkout or procedure continues at step 89. Of course, the check out procedure could also refer to a safety check performed (could be scanned by a barcode reader) and displayed on a health services provider's terminal prior to dispersing and delivering pharmaceuticals to the consumers.

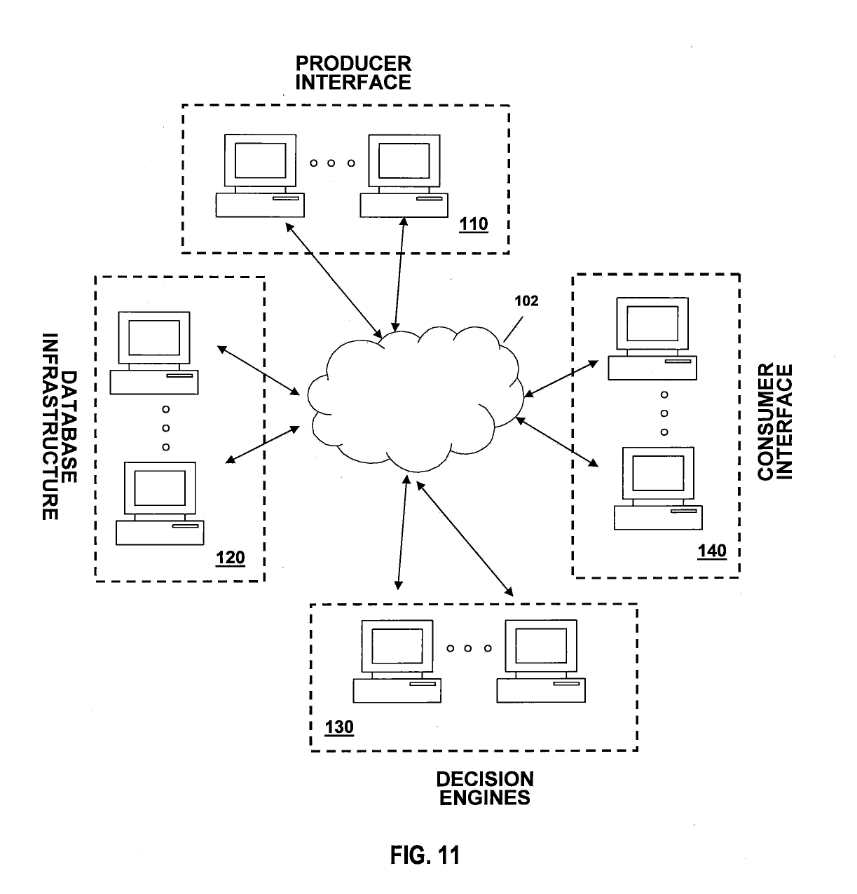

FIG. 11 illustrates a computer hardware and network diagram showing an exemplary embodiment of hardware on which system 100 operates. System 100 is embodied as computer software running on one or more computer systems, all communicating through a network 102 or other communication means.

1. A system for monitoring consumer exposure to sensitivity or nutritional factors comprising:
a database infrastructure storing product information for a plurality of products;
a producer interface through which a product producer can input product information to be stored in the database infrastructure; and
a consumer interface through which a consumer can define a profile containing sensitivities or nutritional factor parameter ranges requiring monitoring and which provides feedback to a consumer regarding products being consumed, applied or purchased.

2. The system of claim 1, wherein the product information for each product comprises one or more elements of sensitivity or nutritional factor metadata.

3. The system of claim 2, wherein a consumer's profile defines one or more allergies, diseases or dietary conditions that identify associated sensitivities.

4. The system of claim 3, wherein the one or more elements of sensitivity or nutritional factor metadata comprise allergen metadata.

5. The system of claim 3, wherein the one or more elements of sensitivity or nutritional factor metadata comprises a certification or classification.

6. The system of claim 3, wherein the feedback provided comprises generating an alert when a consumer attempts to consume, apply or purchase a product that is either associated with sensitivities or outside nutritional factor parameter ranges defined in that consumer's profile.

7. The system of claim 6, wherein the alert comprises one of an e-mail, text audible, or visual message.

8. The system of claim 7, wherein content of the alert is determined by an alert level defined in a consumer's profile.

9. The system of claim 3, further including a rules engine facilitating the monitoring of sensitivities or nutritional factor parameter ranges defined in a consumer's profile by comparing those sensitivities or nutritional factor parameter ranges to the one or more elements of sensitivity or nutritional factor metadata associated with products selected by the consumer for consumption, application or purchase.

10. The system of claim 3, further including a search engine permitting consumers to search products stored in the database infrastructure by identifying one or more elements of sensitivity or nutritional factor metadata

11. The system of claim 10, wherein the database infrastructure comprises a product metadata database including entries for elemental products and compound products, the compound products comprising one or more elemental products [[and]] one or more compound products, or a combination of elemental products and compound products.

12. The system of claim 11, wherein the search engine permits a consumer to search for elemental products and compound products defined in the product metadata database by comparison to the sensitivities or nutritional factor parameter ranges defined in that consumer's profile.

13. The system of claim 11, wherein the database infrastructure further comprises a use metadata database including entries for menus, recipes or shopping lists, each menu, recipe or shopping list comprising one or more defined elemental or compound products.

14. The system of claim 11, wherein the consumer interface further permits a consumer to define new menus, recipes and shopping lists by excluding products associated with allergen, disease or nutritional factor parameter ranges defined in that consumer's profile.

15. The system of claim 9, further comprising an interface to an electronic shopping cart or a barcode scanner permitting the rules engine to determine if products added to the electronic shopping cart or scanned by the barcode scanner are either associated with sensitivities or outside nutritional factor parameter ranges defined in a consumer's profile.

16. A method for monitoring a consumer's exposure to sensitivity or nutritional factors comprising:
monitoring a product selected for consumption, application or purchase by the consumer to identify if the product is associated with a defined sensitivity or is outside a defined nutritional parameter range; and
alerting the consumers when such products are selected to be consumed, applied or purchased.

17. The method of claim 16, wherein the sensitivities or nutritional factor parameter range, and an alert level for each associated sensitivity or nutritional factor parameter range are defined in a profile associated with the consumer,

18. The method of claim 17, wherein the action taken in the alerting step is determined by the alert level defined for each sensitivity determined to be present in a product.

19. The method of claim 16, wherein the alert comprises one of an e-mail, text audible, or visual message.

20. The method of claim 18, wherein the monitoring comprises interfacing with an electronic shopping cart or barcode scanner, and determining if products added to that cart or scanned by the scanner are associated with a defined sensitivity or outside a defined nutritional parameter range.
